(19) United States
(12) Patent Application Publication
(10) Pub. No.: US 2026/0044820 A1
(43) Pub. Date: Feb. 12, 2026

(54) INFORMATION PROCESSING METHOD, LOADING METHOD, COMPUTER PROGRAM, AND INFORMATION PROCESSING DEVICE

(71) Applicant: MITSUBISHI HEAVY INDUSTRIES, LTD., Tokyo (JP)

(72) Inventors: Yuichi KOGA, Tokyo (JP); Daishi IRIE, Tokyo (JP); Hiroshi ENDOH, Tokyo (JP)

(73) Assignee: MITSUBISHI HEAVY INDUSTRIES, LTD., Tokyo (JP)

(21) Appl. No.: 18/998,318

(22) PCT Filed: Feb. 24, 2023
(86) PCT No.: PCT/JP2023/006862

§ 371 Date: Jan. 24, 2025

(30) Foreign Application Priority Data
Aug. 22, 2022 (JP) 2022-131972

(51) Int. Cl. G06Q 10/087; B65G 57/03

(52) U.S. Cl. CPC G06Q 10/08741; B65G 57/03

(57) ABSTRACT

An information processing method includes: acquiring, for each of a plurality of pallets, loading information indicating the type and number of articles allocated to the pallet as well as a stacking order of the articles on the pallet; and setting a loading order indicating order of the pallets where loading is performed, based on the loading information regarding the pallets.

### FIELD

The present disclosure relates to an information processing method, a loading method, a computer program, and an information processing device.

### BACKGROUND

There is a known method for creating a loading plan of articles for pallets. In Patent Literature 1, it is described to generate, as an optimal loading plan, a loading plan that corresponds to a storage request and uses the least number of members to be loaded

### CITATION LIST

### Patent Literature

Patent Literature 1: Japanese Patent Application Laid-open No. 2020-83486

### SUMMARY

### Technical Problem

Note here that it is required to create a loading plan appropriately in accordance with the work content.

The present disclosure is designed to overcome such an issue, and an object thereof is to provide an information processing method, a loading method, a computer program, and an information processing device capable of appropriately creating a loading plan in accordance with the work content.

Solution to Problem An information processing method according to the present disclosure includes the steps of: acquiring, for each of a plurality of pallets, loading information indicating a type and a number of articles allocated to the pallet as well as a stacking order of the articles on the pallet; and setting a loading order indicating order of the pallets where loading is performed, based on the loading information regarding the pallets.

A loading method according to the present disclosure is for loading the articles on the pallets based on the loading information and the loading order.

A computer program according to the present disclosure causes a computer to execute the steps of: acquiring, for each of a plurality of pallets, loading information indicating a type and a number of articles allocated to the pallet as well as a stacking order of the articles on the pallet; and setting a loading order indicating order of the pallets where loading is performed, based on the loading information regarding the pallets.

An information processing device according to the present disclosure includes: a loading information acquisition unit that acquires, for each of a plurality of pallets, loading information indicating a type and a number of articles allocated to the pallet as well as a stacking order of the articles on the pallet; and a loading order setting unit that sets a loading order indicating order of the pallets where loading is performed, based on the loading information regarding the pallets.

### Advantageous Effects of Invention

According to the present disclosure, it is possible to appropriately create a loading plan in accordance with the work content.

### BRIEF DESCRIPTION OF DRAWINGS

FIG. 1 is a schematic diagram of a loading system according to an embodiment.

FIG. 2 is a schematic block diagram of an information processing device according to the present embodiment.

FIG. 3 is a flowchart indicating the procedure for creating a loading plan by the information processing device.

FIG. 4 is a schematic diagram for describing setting of article information.

FIG. 5 is a schematic diagram for describing setting of article information.

FIG. 6 is a schematic diagram for describing setting of article information.

FIG. 7 is a schematic diagram for describing setting of article information.

FIG. 8 is a processing flow for describing a method for allocating individual articles.

FIG. 9 is a processing flow for describing a method for allocating whole articles.

FIG. 10 is a schematic diagram for describing setting of stacking information.

FIG. 11 is a schematic diagram for describing setting of stacking information.

FIG. 12 is a schematic diagram for describing setting of stacking information.

FIG. 13 is a schematic diagram for describing setting of stacking information.

FIG. 14 is a flowchart for describing a processing flow for setting loading information.

FIG. 15 is a schematic diagram for describing setting of the loading order.

FIG. 16 is a flowchart for describing a processing flow for setting the loading order and use pallets.

FIG. 17 is a schematic diagram for describing setting of the loading order according to a second embodiment.

FIG. 18 is a flowchart for describing a processing flow for setting the loading order according to the second embodiment.

FIG. 19 is a flowchart for describing a processing flow for setting the use pallet according to the second embodiment.

### DESCRIPTION OF EMBODIMENTS

Hereinafter, preferable embodiments of the present disclosure will be described in detail with reference to the accompanying drawings. Note that the present disclosure is not limited by the embodiments but also includes, when there are a plurality of embodiments, combinations of each of the embodiments.

### First Embodiment

### Loading System

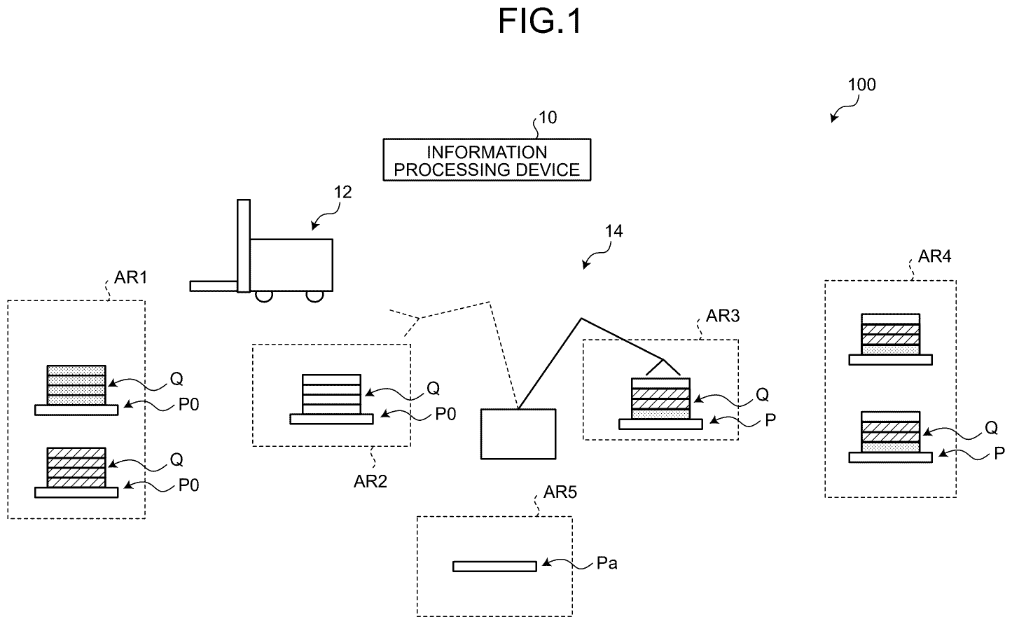

FIG. 1 is a schematic diagram of a loading system according to a first embodiment. A loading system 100 according to the present embodiment is a system for loading articles Q on pallets P in a facility W based on a loading plan. In more detail, the loading system 100 according to the present embodiment transfers the articles Q loaded on supply pallets P0 to the pallets P. The facility W is a logistics-managed facility, such as a warehouse, for example, but may be also be any facility where operations for loading the articles Q on the pallets P are performed. The articles Q are loaded on the pallets P, which are products and the like to be shipped, for example. Note here that the pallet P is defined by the Japan Pallet Association as “a structure that has a surface for placing cargo grouped into a single unit and that can be loaded, unloaded, transported, and stored by hand or by dedicated vehicles such as forklift trucks, including those with superstructures”. In the present embodiment, the pallet P refers to a container or platform on which articles Q are loaded. In other words, the pallet herein is not limited to the so-called flat platform, but also includes a roll-box pallet and the like, and may also be of any shape. Like the pallet P, the supply pallet P0 may also be a container or platform (the so-called pallet) on which the articles Q are loaded. In the present embodiment, only one type of articles Q are loaded on a single supply pallet P0, whereas a plurality of types of articles Q may be loaded on the pallet P depending on the work content (shipping order). In the present embodiment, a plurality of articles Q are loaded on the pallet P in a layered manner. That is, for example, layers with a plurality of articles Q arranged thereon are stacked on the pallet P. The type and placement order of the articles Q on a single layer of the pallet P as well as the stacking order on the pallet P are determined in a loading plan.

As illustrated in FIG. 1, the loading system 100 includes an information processing device 10, a mobile body 12, and a loading device 14. The information processing device 10 is a device that creates a loading plan for loading the articles Q on the pallets P, and details thereof will be described below. The mobile body 12 is a mobile body that transports the supply pallets P0 and the pallets P. For example, the mobile body 12 may be a forklift, and more specifically, may be the so-called automated guided vehicle (AGV) or automated guided forklift (AGF). The loading device 14 is a device (robot) that stacks the articles Q on the pallet P, which is the so-called palletizer. Note that a plurality of the mobile body 12 and a plurality of the loading device 14 may be provided in the facility W.

### Facility

The facility W has an article storage area AR1 where the articles Q are placed, a supply pallet placement area AR2 where the supply pallets P0 are placed, a pallet placement area AR3 where the pallets P are placed, a shipment placement area AR4 where the loaded pallets P are placed, and an empty pallet placement area AR5 where emptied supply pallets P0 are placed. In the article storage area AR1, the articles Q that are planned to be loaded on the pallets P are stored. In the example illustrated in FIG. 1, the articles Q that are loaded on the supply pallet P0 are stored in the article storage area AR1. However, the articles Q that are not loaded on the supply pallet P0 may also be stored therein. In this case, for example, the loading device 14 may also be provided in the article storage area AR1 to execute the operation for loading the articles Q on the supply pallet P0. The supply pallet placement area AR2 is the area where the supply pallets P0 loaded with the articles Q are placed, and the pallet placement area AR3 is the area where the pallets P for loading the articles Q are placed. The loading device 14 picks up the article Q from the supply pallet P0 placed in the supply pallet placement area AR2, and stacks the picked-up article Q on the pallet P placed in the pallet placement area AR3. The shipment placement area AR4 is the area where the pallets P on which the stacking operation is completed in the pallet placement area AR3 are placed, from which the pallets P may be shipped. The empty pallet placement area AR5 is the area where the pallets (supply pallets P0) that are empty and not loaded with the articles Q are placed. That is, for example, a supply pallet Pa, which is emptied after the articles Q are transferred, is placed in the empty pallet placement area AR5. The transport of the supply pallets P0 and the pallets P between each of the areas may be performed by the mobile body 12. Note that the layout of the facility W is an example, and it is not limited to the above description.

### Information Processing Device

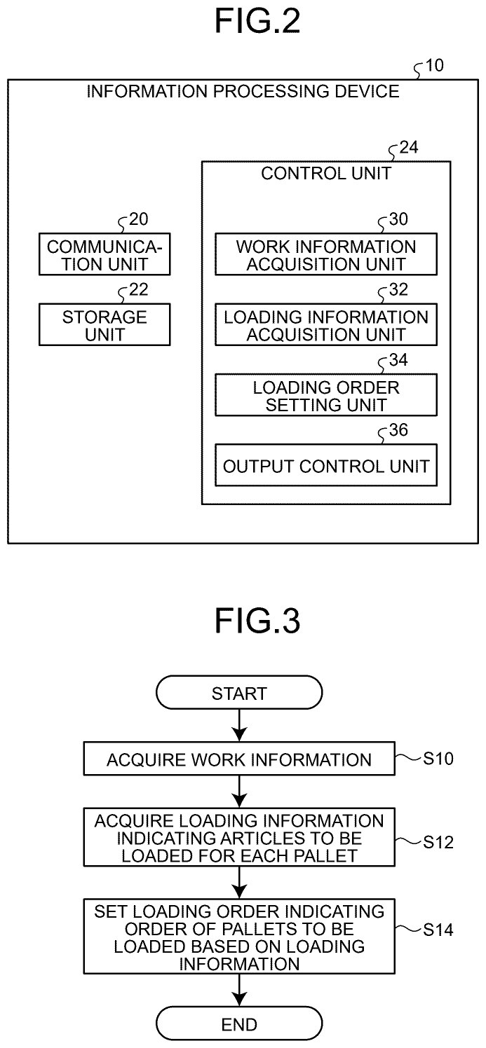

FIG. 2 is a schematic block diagram of the information processing device according to the present embodiment. The information processing device 10 is a device that generates a loading plan for loading the articles Q on the pallets P. While the information processing device 10 is provided in the facility W in the example illustrated in FIG. 1, it may also be installed in arbitrary places. The information processing device 10 is a computer and, as illustrated in FIG. 2, includes a communication unit 20, a storage unit 22, and a control unit 24. The information processing device 10 may also have an input unit that receives input from the user, and an output unit that outputs information (for example, a display unit that displays images). Note that the information processing device 10 may be configured with a single device, integrated with other devices, or may be configured as a system that is a combination of various kinds of devices such as an arithmetic circuit and a data server, and it is not limited to any particular configuration.

The communication unit 20 is a communication module that communicates with external devices, and it is an antenna and the like, for example. While the information processing device 10 communicates with external devices via wireless communication, it is possible to use wired communication, and any communication scheme may be used. The storage unit 22 is a memory that stores various types of information such as the arithmetic operation content and a program of a control unit 24, and includes, for example, at least one of main memory devices such as a random access memory (RAM) and a read only memory (ROM) and an external memory device such as hard disk drive (HDD). The program for the control unit 24 stored in the storage unit 22 may be stored in a recording medium that can be read by the information processing device 10.

The control unit 24 is a processing device that executes arithmetic calculations and includes, for example, an arithmetic circuit of a central processing unit (CPU) or the like. The control unit 24 includes a work information acquisition unit 30, a loading information acquisition unit 32, a loading order setting unit 34, and an output control unit 36. The control unit 24 reads and executes a program (software) from the storage unit 22 to realize the work information acquisition unit 30, the loading information acquisition unit 32, the loading order setting unit 34, and the output control unit 36, and executes the processing thereof. Note that the control unit 24 may execute such processing by a single CPU, or it may be provided with a plurality of CPUs and executes the processing with those CPUs. Also, at least part of the processing of the work information acquisition unit 30, the loading information acquisition unit 32, the loading order setting unit 34, and the output control unit 36 may be realized by hardware circuitry.

The work information acquisition unit 30 acquires work information indicating the work content for generating the loading plan. The loading information acquisition unit 32 acquires loading information that is information indicating the articles Q planned to be loaded on the pallets P. The loading order setting unit 34 sets the stacking order of the pallets P to be loaded (the order in which the pallets P to be shipped are fully prepared) based on the loading information. The output control unit 36 outputs the information of the loading plan including loading information and loading order to external devices via the communication unit 20. For example, the output control unit 36 transmits the information of the loading plan to the mobile body 12 and the loading device 14, and causes the mobile body 12 and the loading device 14 to execute the work based on the loading plan. The specific details of the processing are described below.

### Processing of Information Processing Device

FIG. 3 is a flowchart indicating the procedure for creating a loading plan by the information processing device 10. As illustrated in FIG. 3, the information processing device 10 causes the work information acquisition unit 30 to acquire work information (step S10), causes the loading information acquisition unit 32 to acquire loading information indicating, for each pallet P, the articles Q that are planned to be loaded on the pallet P (step S12), and causes the loading order setting unit 34 to set the loading order based on the loading information for the pallets P (step S14). By creating the loading plan to include the loading information and the loading order set in such a manner, the type and number of articles Q to be loaded on the pallet P, the arrangement of the articles Q on each layer of the pallet P, the way each layer of the pallet P is stacked, and the order in which the pallets P to be shipped are fully prepared can be set, thereby making it possible to make a loading plan appropriately in accordance with the work content. Hereinafter, the content of each step will be described in more detail.

### Acquisition of Work Information

A work information acquisition method indicated at step S10 will be described in a specific manner. The work information acquisition unit 30 may acquire work information by any method and, for example, may acquire the work information from a device (higher-level system) that manages the facility W via the communication unit 20. The work information is information used for setting the loading information. The work information may be any information that can be used for setting the loading information. However, it is preferable to contain at least information (article information) indicating the articles Q to be shipped. More specifically, in the present embodiment, the work information includes shipping destination information, article information indicating the articles Q to be shipped to that destination, and supply pallet information indicating the supply pallets P0 on which the articles Q to be shipped are loaded. The shipping destination information is information that indicates the shipping destination for the current work. The article information is information indicating, for each destination, the type and number of articles Q planned to be shipped. In addition to the type and number of the articles Q, the article information may also include at least one (preferably all) of information indicating the size of the article Q to be shipped (for example, length in the vertical direction, horizontal direction, and height directions), information indicating the size of one layer of the pallet P (for example, length in the vertical direction and horizontal direction), information indicating the weight of the article Q, and information of maximum placeable number indicating the maximum number of articles Q that can be placed on a single layer of the pallet P. The supply pallet information includes information regarding the type and number of the articles Q to be loaded on the supply pallet P0.

### Acquisition of Loading Information

A loading information acquisition method indicated at step S12 will be described hereinafter in a specific manner. The loading information acquisition unit 32 may acquire loading information by any method and, for example, may acquire loading information from the higher-level system or the like through communication. However, in the present embodiment, it sets the loading information by itself based on the work information. The loading information acquisition unit 32 sets, as the loading information, the article information indicating the type and number of the articles Q to be allocated to the pallet P and stacking information indicating how the articles Q indicated in the pallet information are stacked on the pallet P. The stacking information can also be referred to as the information indicating the arrangement of the articles Q on each layer and the order of each of the layers in the stacking direction.

### Setting of Article Information

### Calculation of Number of Individual Articles

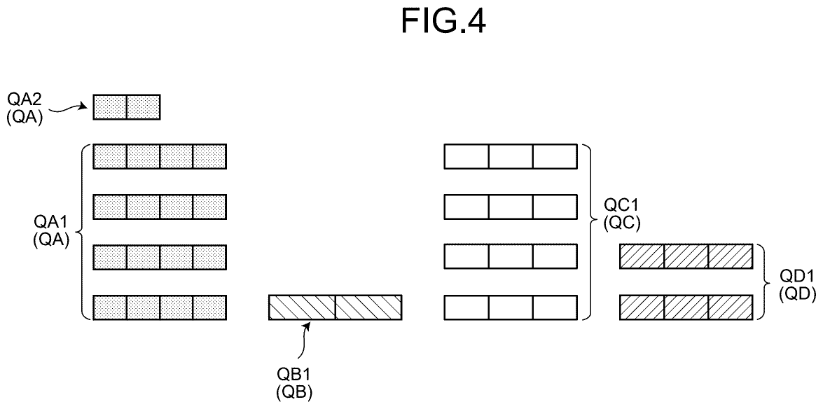

FIG. 4 to FIG. 7 are schematic diagrams for describing setting of the article information. When setting the article information, the loading information acquisition unit 32 classifies the articles Q to be shipped to the target destination into whole articles and individual articles, and calculates the number of the articles Q classified as individual articles (number of individual articles). The whole article refers to the articles Q stacked to occupy all of each layer, assuming that the articles Q are stacked on the pallet P such that the articles Q occupy the whole single layer. An individual article refers to the article Q that could not occupy the whole single layer in that case and is left over. In other words, the whole article means the articles Q that are loaded over the entire loadable area in a single layer of the pallet P, and the individual article is the article Q that is loaded only in a part of the loadable area in a single layer of the pallet P. The loading information acquisition unit 32 classifies the articles Q into the whole articles and the individual articles and calculates the number of individual articles for the articles Q based on the information of the number of the articles Q to be shipped to the target shipping destination and the information of the maximum loadable number of the articles Q indicated in the work information. In the present embodiment, the loading information acquisition unit 32 calculates, as the number of individual articles, the remainder when the number of the articles Q to be shipped to the destination is divided by the maximum loadable number. In other words, referring to a case where 18 articles Q are to be shipped and the maximum loadable number is 4, when the articles Q are loaded on the pallet P such that the articles Q occupy the whole single layer, the articles Q are stacked in 4 layers and 2 pieces thereof are left over. Therefore, in this example, the number of whole articles is 16 in four layers, and the number of individual articles is 2. When there is no remainder when the number of the articles Q is divided by the maximum loadable number (when divisible), the number of individual articles is zero because all of the articles are classified as the whole articles.

The loading information acquisition unit 32 classifies the articles Q into the whole articles and the individual articles for each kind of the articles Q to be shipped to the target destination, and calculates the number of individual articles for each of the articles Q. FIG. 4 illustrates an example of a planned shipment to ship 18 articles QA, 2 articles QB, 12 articles QC, and 6 articles QD to a certain destination, in which the maximum loadable number of the articles QA is 4, the maximum loadable number of the articles QB is 2, and the maximum loadable number of the articles QC and QD is 3. In this case, in the example illustrated in FIG. 4, the articles QA are classified into 16 whole articles QA1 and 2 individual articles QA2, while the articles QB, QC, and QD do not include individual articles and all are classified into whole articles QB1, QC1, and QD1.

### Allocation of Individual Article

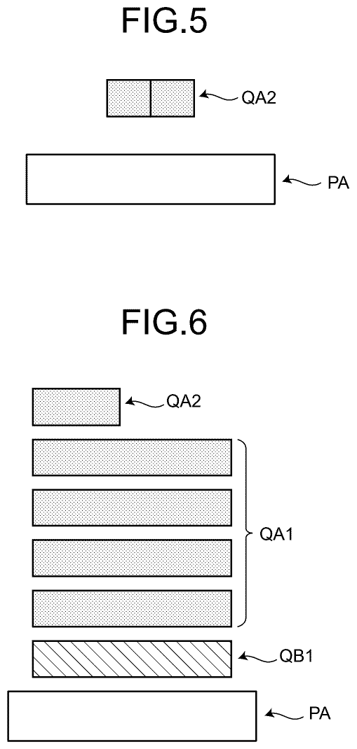

Next, the loading information acquisition unit 32 allocates the individual articles (the number of articles Q classified as individual articles) to the pallet P. Allocation of the article Q to the pallet P means to select the article Q that is planned to be loaded on that pallet P (select the pallet P on which the article Q is planned to be loaded). The loading information acquisition unit 32 explores whether each individual article of one type of articles Q can be placed on a single layer of the pallet P. The loading information acquisition unit 32 explores whether there is an arrangement of individual articles that do not overlap each other on a single layer based on the size of the article Q and the size of the single layer of the pallet P indicated in the work information. The exploration method herein may be any method, and the Bottom-Left method may be used, for example. When there is an arrangement where the individual articles do not overlap each other on a single layer, the loading information acquisition unit 32 allocates the individual articles of the articles Q to that pallet P. In the meantime, when there is no arrangement where individual articles do not overlap each other on a single layer, the loading information acquisition unit 32 does not allocate the individual articles of the articles Q to that pallet P. For example, FIG. 5 illustrates an example where two individual articles QA2 (all of the individual articles QA2) are allocated to a pallet PA since it is determined that the two individual articles QA2 can be placed on a single layer of the pallet PA. When it is determined that the individual articles are not allocated to the pallet P, it is possible to explore whether the individual articles can be allocated to other pallets P, or to divide all individual articles into a plurality of groups and determine whether it is possible to allocate the individual articles to the pallet P by each group.

As described, in the present embodiment, when the individual articles of one type of the articles Q can be placed on a single layer, the individual articles are allocated to that pallet PA. However, the criteria for allocation are not limited thereto. For example, when there is an arrangement where the individual articles do not overlap each other on a single layer, and the total height, which is the sum of the height of the individual article and the height of all the stacked whole articles of the same type as the individual article (whole article height), is equal to or less than a predetermined threshold height, the individual articles may be allocated to that pallet PA. In other words, even when there is an arrangement where the individual articles do not overlap each other on a single layer, if the total height of the stacked individual articles and whole articles of the same type is higher than the threshold height, the individual articles may not be allocated to that pallet PA. Note that the height of the whole articles may be calculated arbitrarily. For example, it may be the value calculated by multiplying the number of layers of the whole articles, which is calculated by dividing the total number of whole articles by the maximum loadable number, by the height of the whole articles. The same applies hereinafter. In other words, in the example illustrated in FIG. 4, for example, there are four layers when all of the whole articles QA1 of the articles QA are stacked, so the total height is the sum of the height of the four layers of the whole articles QA1 and the height of the individual article QA2. When the total height is higher than the threshold height, the individual articles QA2 may not need to be allocated to that pallet PA.

When there are individual articles of a plurality of types of articles Q for a single shipping destination, the loading information acquisition unit 32 allocates, for each type of the articles Q, the individual articles to the pallet P in the same manner. The order of allocating the individual articles of each type of articles Q may be determined arbitrarily. However, it is preferable to allocate the individual articles in order from those with the lowest height among a plurality of types of articles Q.

When there are individual articles in a plurality of types of articles Q, the loading information acquisition unit 32 may allocates a plurality of types of individual articles to a single layer of a single pallet P. Specifically, the loading information acquisition unit 32 explores whether there is an arrangement where, on a single layer, the individual articles do not overlap with the already allocated individual article and the individual articles to be allocated this time do not overlap each other. When there is an arrangement where the individual articles do not overlap with the already allocated individual article and the individual articles to be allocated this time do not overlap each other, the loading information acquisition unit 32 allocates the individual articles to that pallet P. In the meantime, when there is no such arrangement, the loading information acquisition unit 32 does not allocate the individual articles to that pallet P and allocates those to another pallet P, for example. That is, for example, when there is the pallet PA where two individual articles QA2 are already allocated and another type of two individual articles can be placed on the same layer with the two individual articles QA2 without overlapping, those two individual articles are also allocated to the same layer of the pallet PA as the individual articles QA2. In the meantime, when those individual articles cannot be placed without overlapping with the individual articles QA2 on the same layer, those individual articles are allocated to another pallet P.

The loading information acquisition unit 32 executes the processing for allocating the individual articles to the pallet P for each of the individual articles.

### Allocation of Whole Articles to Pallet With Already Allocated Individual Articles

The loading information acquisition unit 32 allocates the whole articles (the number of articles Q classified as whole article) to the pallet P to which the individual articles are already allocated. The loading information acquisition unit 32 preferentially allocates, to the pallet P, the whole articles of the same type as the individual articles that are already allocated. Specifically, the loading information acquisition unit 32 selects the whole articles of the same type as the individual articles from among the whole articles for the target shipping destination, and determines whether the selected whole articles can be allocated to the pallet P to which the individual articles are allocated. The loading information acquisition unit 32 calculates the total height of the selected whole articles (the stacked height of all the whole articles) and the already-allocated individual articles and, when the total height is equal to or less than the threshold height, determines that all of the selected whole articles can be allocated to that pallet PA and performs allocation. In the meantime, when the total height is higher than the threshold height, the loading information acquisition unit 32 does not allocate the selected whole articles to that pallet PA and allocates those to another pallet P. In the example illustrated in FIG. 6, all of the whole articles QA1 are allocated to the pallet PA, since the total height of the whole articles on four layers including all of the whole articles QAI and the height of the individual article QA2 is less than the threshold height. As described, by preferentially allocating the whole articles of the same type as the individual article, it is possible to reduce the work time by suppressing increase in the number of types of articles Q to be loaded on the pallet PA and suppressing the number of times the supply pallet P0 to be loaded is changed.

The loading information acquisition unit 32 may also allocate other types of whole articles to the pallet P to which the individual articles and whole articles are already allocated. In this case, the loading information acquisition unit 32 selects the type of whole articles that are not being allocated from among the whole articles for the target shipping destination, and determines whether the selected whole articles can be allocated to the pallet P to which individual articles and whole articles are already allocated. The loading information acquisition unit 32 calculates the total higher of the height of the selected whole articles (the height of all the stacked whole articles), the height of the already-allocated whole articles, and the height of the already-allocated individual articles. When the total height is equal to or less than the threshold height, the loading information acquisition unit 32 determines that it is possible to allocate all of the selected whole articles to the pallet P and performs allocation. In the meantime, when the total height is higher than the threshold height, the loading information acquisition unit 32 does not allocate the selected whole articles to that pallet P and allocates those to another pallet P. In the example illustrated in FIG. 6, all of the whole articles QB1 are allocated to the pallet PA, since the total height of all of the whole articles QB1 in a single layer, the height of the whole articles QA1 in four layers, and the height of the individual article QA2 is less than the threshold height.

Even when the whole articles of the same type as the individual articles cannot be allocated to the pallet P to which the individual articles are allocated, whole articles of different types may be allocated to the pallet P. In this case, the loading information acquisition unit 32 selects the type of the whole articles that are not being allocated from among the whole articles for the target shipping destination, calculates the total height of the height of the selected whole articles (the stacked height of all of the whole articles) and the height of the already-allocated individual articles and, when the total height is equal to or less than the threshold height, allocates all of the selected whole articles to the pallet PA. In the meantime, when the total height is higher than the threshold height, the loading information acquisition unit 32 does not allocate the selected whole articles to that pallet P and allocates those to another pallet P.

The loading information acquisition unit 32 sequentially selects the types of whole articles that are not being allocated, and repeats the above-described processing for the pallet P to which the individual articles are allocated so as to allocate the whole articles to the pallets P to which the individual articles are allocated.

The loading information acquisition unit 32 executes the whole article allocation processing described above for each of the pallets P to which the individual articles are allocated.

### Allocation of Whole Articles to Pallet Where Individual Articles are not Allocated

After the processing for allocating the whole articles to the pallet P to which the individual article is allocated, the loading information acquisition unit 32 allocates, to the pallet P to which individual articles are not allocated, the whole articles that are not being allocated (the number of articles Q classified as the whole articles). The loading information acquisition unit 32 selects the type of whole articles that are not being allocated from among the whole articles for the target shipping destination, and determines whether the selected whole articles can be allocated to the pallet P to which individual articles are not allocated. The loading information acquisition unit 32 calculates the total height of the selected whole articles (the stacked height of all the whole articles) and, when the total height of the whole articles is equal to or less than the threshold height, determines that all of the selected whole articles can be allocated to that pallet P and performs allocation. In the meantime, when the height of the whole articles is higher than the threshold height, the loading information acquisition unit 32 does not allocate the selected whole articles to that pallet P. As described, by preferentially allocating the whole articles of the same type, it is possible to reduce the work timer by suppressing increase in the number of types of the articles Q to be loaded on the pallet PA and suppressing the number of times the supply pallet P0 to be loaded is changed.

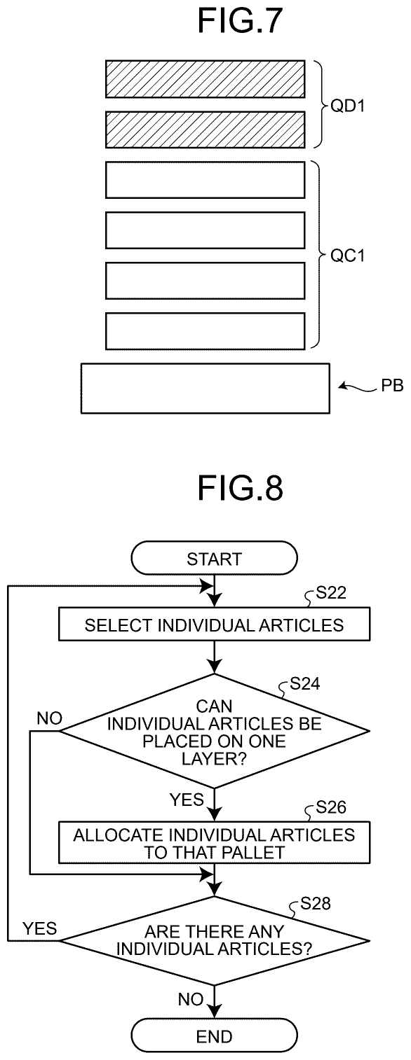

The loading information acquisition unit 32 may also allocate other types of whole articles to the pallet P to which the individual articles are not allocated but whole articles are already allocated. In this case, the loading information acquisition unit 32 selects the type of whole articles that are not being allocated from among the whole articles for the target shipping destination, and determines whether the selected whole articles can be allocated to the pallet P to which whole articles are already allocated. The loading information acquisition unit 32 calculates the total height of the height of the selected whole articles and the height of already-allocated whole articles and, when the total height is equal to or less than the threshold height, determines that all of the selected whole articles can be allocated to that pallet P and performs allocation. In the meantime, when the total height is higher than the threshold height, the loading information acquisition unit 32 does not allocate the selected whole articles to that pallet P and allocates those to another pallet P. In the example illustrated in FIG. 7, all of the whole articles QC1 and QD1 are allocated to a pallet PB, since the total height of the height of all the whole articles QC1 in four layers and the height of all the whole articles QC1 in two layers is less than the threshold height.

The loading information acquisition unit 32 sequentially selects the types of whole articles that are not being allocated, and repeats the above-described processing for the pallet P to which the individual articles are allocated so as to allocate the whole articles to the pallet P to which the individual articles are not allocated. In other words, when whole articles cannot be allocated anew to a single pallet P, a new pallet P is selected and the whole articles are allocated to the newly selected pallet P in the same manner. In the above explanation, all of the whole articles of one type are allocated to a single pallet P. However, when all of the whole articles cannot be allocated to any of the pallets P, all of the whole articles may be divided for each layer and allocated to the pallets P by each layer.

The loading information acquisition unit 32 allocates, for each of the shipping destinations, individual articles and whole articles to the pallets P in the method described above such that all of the articles Q for the shipping destination are allocated to any one of the pallets P. Thereby, article information indicating the type and number of articles Q to be allocated to each of the pallets P is set for each of the shipping destinations.

Furthermore, in the above explanation, the whole articles are selected and allocated in order for the pallet P to which the individual articles are already allocated and to the pallet P to which the individual articles are not allocated. Although the order of selecting the whole articles at that time may be arbitrary, the loading information acquisition unit 32 may alternately select, from among the types of whole articles that are not being selected, the type of whole articles to have the highest height (the stacked height of all of the whole articles) and the type of whole articles to have the smallest height, for example. That is, for example, the whole articles to have the highest height is selected from among the unselected whole articles, then the whole articles to have the smallest height is selected from among the remaining (unselected) whole articles, and then the whole articles to have the highest height is selected from among the remaining whole articles. As described, by alternately selecting the whole articles to have the highest height and the whole articles to have the smallest height, it is possible to stack the whole articles as high as possible on the pallet P, thereby making it possible to reduce the number of pallets P to be used. Furthermore, the loading information acquisition unit 32 may alternately select, from among the types of whole articles that are not being selected, the type of whole articles with the largest number of pieces and the type of whole articles with the smallest number of pieces, for example. That is, for example, the whole articles with the largest number of pieces are selected from among the unselected whole articles, then the whole articles with the smallest number of pieces are selected from among the remaining (unselected) whole articles, and then the whole articles with the largest number of pieces is selected from among the remaining whole articles. As described, by alternately selecting the whole articles with the largest number of pieces and the whole articles with the smallest number of pieces, it is possible to stack the whole articles as many as possible on the pallet P, thereby making it possible to reduce the number of pallets P to be used.

Moreover, assuming that the method of alternately selecting the whole articles to have the highest height and the whole articles to have the smallest height is a first selection method and the method of alternately selecting the whole articles with the largest number of pieces and the whole articles with the smallest number of pieces is a second selection method, the loading information acquisition unit 32 may determine whether to use the first selection method or the second selection method based on the number of pallets P required for allocating all of the articles Q for a single shipping destination. In this case, for example, the loading information acquisition unit 32 selects unselected whole articles using the first selection method, and sets the article information by the above-described method such that all of the articles Q for the shipping destination are allocated to any one of the pallets P (allocation of individual articles and whole articles). Furthermore, the loading information acquisition unit 32 selects unselected whole articles using the second selection method, and sets the article information by the above-described method such that all of the articles Q for the shipping destination are allocated to any one of the pallets P (allocation of individual articles and whole articles). The loading information acquisition unit 32 may compare the total number of the pallets P required for allocating all of the articles Q by using the first selection method with the total number of the pallets P required for allocating all of the articles Q by using the second selection method, and may treat the article information set by the selection method that requires the smaller total number of pallets P as the article information used for the loading plan.

### Article Information Setting Flow

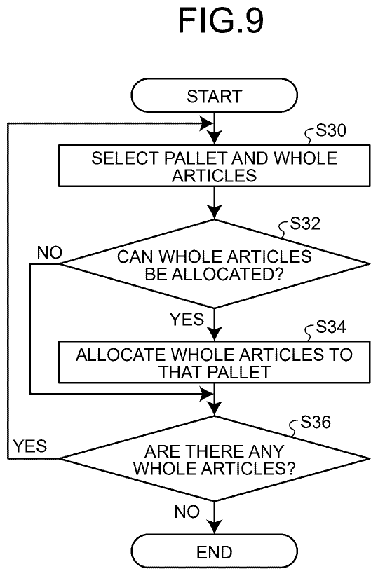

A processing flow for setting the above-described article information will be described. FIG. 8 is a processing flow for describing an individual article allocation method, and FIG. 9 is a processing flow for describing a whole article allocation method. As illustrated in FIG. 8, when allocating the individual articles to the pallet P, the loading information acquisition unit 32 selects individual articles (step S22), determines whether all of the selected individual articles can be placed on a single layer of the selected pallet P (step S24), when determined to be placed on a single layer (Yes at step S24), allocates all of the individual articles to that pallet P (step S26), and when there is no other individual article (No at step S28), ends the present processing. In the meantime, when there are other individual articles (Yes at step S28), the loading information acquisition unit 32 returns to step S22 and continues the processing to select and allocate other individual articles to the pallet P. When the selected individual articles cannot be placed on a single layer of the pallet P (No at step S24), the loading information acquisition unit 32 also proceeds to step S28. When the selected individual article cannot be placed on a single layer of the selected pallet P, it is possible to select another pallet P and determine whether the individual articles can be placed on a single layer of that pallet P.

As illustrated in FIG. 9, when allocating the whole articles to the pallet P, the loading information acquisition unit 32 selects the pallet P and the whole articles (step S30), determines whether all of the selected whole articles can be placed on the selected pallet P (step S32), when determined to be allocatable (Yes at step S32), allocates all of the whole articles to the pallet P (step S34), and when there is no other whole article (No at step S36), ends the present processing. In the meantime, when there are other whole articles (Yes at step S36), the loading information acquisition unit 32 returns to step S30 and continues the processing to select and allocate other individual articles to the pallet P. Also, when the selected whole articles cannot be allocated to the selected pallet P (No at step S32), the loading information acquisition unit 32 also proceeds to step S36. When there are still unallocated whole articles remained after determining that whether all of the whole articles can be allocated to the selected pallet P, the loading information acquisition unit 32 returns to step S30, selects another pallet P, and determines whether the unallocated whole articles can be allocated to that pallet P.

### Setting of Stacking Information

The article information set in the above explanation indicates the type and the number of articles Q (individual articles and whole articles) to be allocated to the pallet P, and how the allocated articles Q are placed on the pallet P is undetermined. Therefore, in the present embodiment, the loading information acquisition unit 32 sets, after setting the article information, the stacking information indicating how the articles Q are stacked on the pallet P. Hereinafter, this will be described in a specific manner.

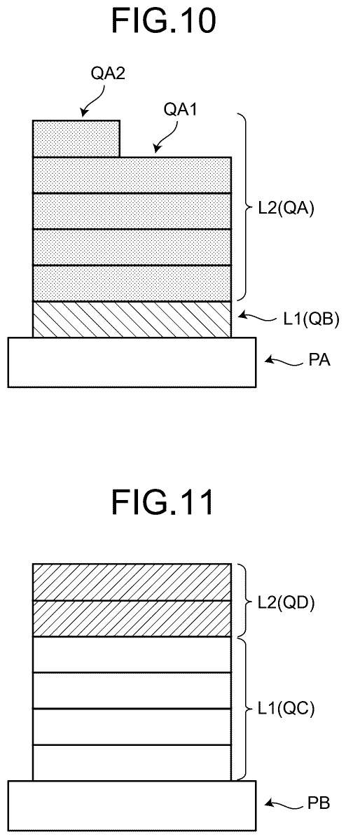

FIG. 10 to FIG. 13 are schematic diagrams for describing setting of the stacking information. The loading information acquisition unit 32 puts the same type of articles Q to be allocated to a single pallet P in a single layer group L and sets, as the stacking information, the order in which the layer groups L are stacked. The layer group L herein can be considered as a set of layers containing the same type of articles Q. A single layer group L may include one layer of the same type of articles Q, or it may include a plurality of layers. The number of layers in the layer group L is, for example, the value acquired by dividing the total number of articles Q by the maximum loadable number. When individual articles are included therein, it is the sum of the value acquired by dividing the total number of articles Q by the maximum loadable number and the number of layers of the individual articles. That is, for example, the layer group L of the articles QA illustrated in FIG. 6 includes a total of five layers with four layers of the whole articles and one layer of the individual article.

The loading information acquisition unit 32 determines whether any individual article is allocated to the pallet P based on the article information of the pallet P. When an individual article is allocated, the loading information acquisition unit 32 sets the layer group L of the articles Q including the individual article as the uppermost layer group that is the layer group placed at the top of that pallet P. In the meantime, the uppermost layer group is not set at this stage for the pallet P to which no individual articles are allocated. As described, by placing the layer group L that contains the individual article on the uppermost layer, the articles Q can be properly stacked. In the layer group L of the articles Q that contains the individual article, the layer of the individual article is set as the uppermost layer among each of the layers of the articles Q.

Furthermore, among the layer groups L included in the pallet P, the loading information acquisition unit 32 determines whether there is a maximum weight layer group that has the heaviest weight of the articles Q on a single layer included in the layer group L, based on the article information of the pallet P. When there is a maximum weight layer group, the loading information acquisition unit 32 sets the maximum weight layer group as the lowermost layer group that is the layer group placed at the bottom of that pallet P. In this case, for example, the loading information acquisition unit 32 can determine whether there is the maximum weight layer group by calculating and comparing the weight of the articles Q on one layer for each layer group L based on the weight of the article Q and the maximum loadable number. When there is no maximum weight layer group, that is, when there are plurality of layer groups L with the maximum weight of articles Q on one layer, for example, it is not necessary to set the lowermost layer group. Thus, by placing the heaviest layer as the lowermost layer, stacking can be achieved by keeping the weight balance.

In the example illustrated in FIG. 10, the articles QA that includes the individual article QA2 and the article QB that includes no individual article are allocated to the pallet PA. Therefore, in the example illustrated in FIG. 10, a layer group L2 of the articles QA is set as the uppermost layer group of the pallet PA, and a layer group L1 of the remaining article QB is set as the layer group below the layer group L2 (the lowermost layer group in this example). Furthermore, in the example illustrated in FIG. 11, the articles QC and QD, which do not include individual articles, are allocated to the pallet PB, and the layer group of the articles QC is the maximum weight layer group. Therefore, in the example illustrated in FIG. 11, the layer group L1 of the articles QC is set as the lowermost layer group of the pallet PB, and the layer group L2 of the remaining articles QD is set as the layer group above the layer group L1 (the uppermost layer group in this example).

Then, the loading information acquisition unit 32 extracts the popular articles (target articles) from among the articles Q allocated to the pallets P for each of the shipping destinations. The popular article herein refers to the article Q that has the largest number of assigned shipping destinations. That is, for example, when the article QD is shipped to three shipping destinations and the articles QA, QB, and QD are shipped to two shipping destinations, the article QD is the popular article. However, the popular article is not limited to being the article Q with the largest number of assigned shipping destinations, but may refer to the type of articles Q selected by any method from the articles Q allocated to the pallets P for each of the shipping destinations. For example, it may refer to the article Q with the largest total number of shipment for each of the shipping destinations.

After extracting the popular article, the loading information acquisition unit 32 selects, from among the pallets P for each of the shipping destinations, a first pallet that has the largest number of allocated popular articles. The loading information acquisition unit 32 sets, as the lowermost layer of the selected first pallet, the layer group L that contains the popular articles allocated to the selected first pallet. When there are a plurality of pallets P that have the largest number of allocated popular articles, any one of those may be selected as the first pallet. Furthermore, when the lowermost layer group of the selected first pallet is already set, the pallet having the largest number of popular articles is selected as a new first pallet from among the unselected pallets P excluding the first pallet, and the same processing is performed.

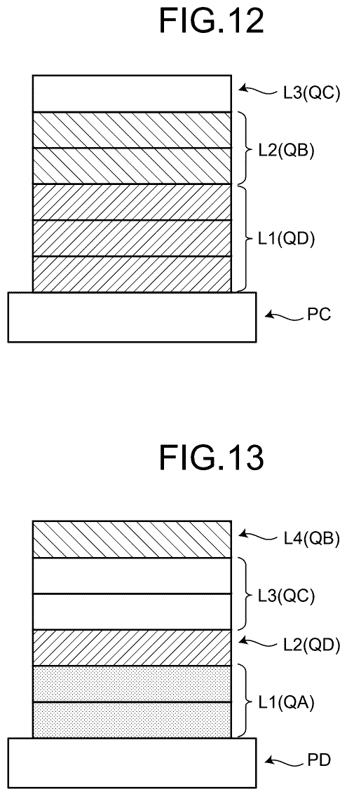

For example, in the example illustrated in FIG. 12, the layer group L1 of the articles QD is set as the lowermost layer group of the pallet PC, since the number of articles QD as the popular articles is the largest among each of the pallets P.

Furthermore, the loading information acquisition unit 32 selects, from among the pallets P for each of the shipping destinations, a second pallet that has the smallest number of allocated popular articles. The loading information acquisition unit 32 sets, as a second layer group that is the second lowest of the selected second pallet, the layer group L that contains the popular articles allocated to the selected second pallet. The second layer group may also be referred to as the layer group directly above the lowermost layer group. When there are a plurality of pallets P that have the smallest number of allocated popular articles, any one of those may be selected as the second pallet. Furthermore, when the second layer group of the selected second pallet is already set, the pallet having the smallest number of popular articles is selected as a new second pallet from among the unselected pallets P excluding the second pallet, and the same processing is performed. For example, in the example illustrated in FIG. 13, the layer group L2 of the articles QD is set as the second layer group of the pallet PD, since the number of articles QD as the popular articles is the smallest among each of the pallets P. In the example illustrated in FIG. 13, the layer group L1 of the articles QA is set as the lowermost layer group since it is the heaviest weight layer group.

After setting the lowermost layer group of the first pallet and the second layer group of the second pallet, the loading information acquisition unit 32 selects the first pallet and the second pallet from among the unselected pallets P that are not selected as the first pallet and the second pallet, and repeats setting processing of the lowermost layer group of the first pallet and setting processing of the second layer group of the second pallet. When the selection of all of the pallets P for the extracted popular articles is completed, the loading information acquisition unit 32 extracts the article Q with the largest number of assigned shipping destinations from among the articles Q excluding the popular articles extracted heretofore as the new popular article, and repeats selection of the first pallet and setting processing of the lowermost layer group thereof and selection of the second pallet and setting processing of the second layer group thereof. As described, by setting the same popular articles for the lowermost layer group of the first pallet and the second layer group of the second pallet, the popular articles can be loaded continuously on the second pallet and the first pallet. This makes it possible to reduce the time required for loading and reduce the load of stacking work.

Then, the loading information acquisition unit 32 extracts the pallet P for which the stacking order of all the layer groups L is not determined (pallet P for which the stacking order of at least some of the layer groups L is not determined). The loading information acquisition unit 32 selects, for the extracted pallet P, the largest layer group with the largest number of articles Q from among the layer groups L for which the stacking order is not determined, and sets the selected largest layer group as the lowermost layer group among the layer groups L for which the stacking order is not determined. That is, for example, when the lowermost layer group is determined but the second layer group (the layer group directly above the lowermost layer) is not determined, the largest layer group is set as the second layer group. When the lowermost layer group and second layer group are already determined, the largest layer group is set as the layer group directly above the second layer group. When there are a plurality of layer groups L that have the largest number of articles Q, any one of those may be selected as the largest layer group.

Then, the loading information acquisition unit 32 selects, for the extracted pallet P, the smallest layer group with the smallest number of articles Q from among the layer groups L for which the stacking order is not determined, and sets the selected smallest layer group as the lowermost layer group among the layer groups L for which the stacking order is not determined. Then, the loading information acquisition unit 32 selects, for the extracted pallet P, the largest layer group with the largest number of articles Q anew from among the layer groups L for which the stacking order is not determined, and sets the selected largest layer group as the lowermost layer group among the layer groups L for which the loading order is not determined. In other words, the loading information acquisition unit 32 sets, for the layer groups L for which the stacking order is not determined, the stacking order such that the largest layer group and the smallest layer group are stacked alternately from the bottom. For example, in the example illustrated in FIG. 12, the stacking order is set in the order of the layer group L1, the layer group L2, and the layer group L3 for the pallet PC, since the largest layer group among the layer groups L in which the stacking groups are undetermined is the layer group L2 that contains the articles QB, and the smallest layer group is the layer group L3 that contains the article QC. Also, in the example illustrated in FIG. 13, for example, the stacking order is set in the order of the layer group L1, the layer group L2, the layer group L3, and the layer group L4 for the pallet PD, since the largest layer group among the layer groups L in which the stacking groups are undetermined is the layer group L3 that contains the articles QC, and the smallest layer group is the layer group L4 that contains the article QB. As described, by alternately stacking the largest layer group and the smallest layer group on a single pallet P, the time for changing the supply pallet P0 for loading a single pallet P can be averaged. This makes it possible to reduce the time required for loading and reduce the workload of loading. That is, for example, when the layer group L with the small number of articles Q is continuously stacked, the stacking of the layer group L being completed early continues. Thus, the change of the supply pallet P0 may not be completed in time, and it may be required to wait until the change of the supply pallet P0 is completed for loading. In the meantime, by alternately stacking the largest layer group and the smallest layer group, it is possible to reduce the chance of waiting until the change of the supply pallet P0 is completed.

The loading information acquisition unit 32 sets the loading information for all of the pallets P by performing the above-described processing for all of the pallets P.

### Loading Information Setting Flow

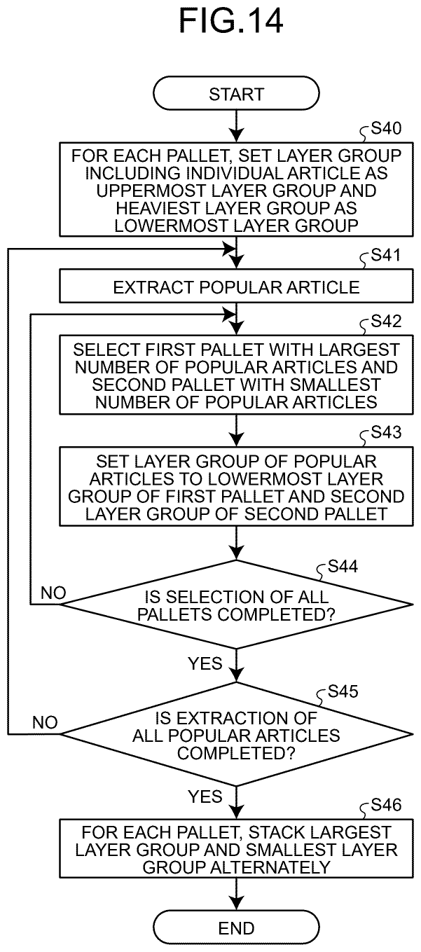

A processing flow for setting the above-described loading information will be described. FIG. 14 is a flowchart for describing the processing flow for setting the loading information. As illustrated in FIG. 14, for each of the pallets P for which the article information is set, the loading information acquisition unit 32 sets the layer group L containing the individual article as the uppermost layer group and the heaviest layer group as the lowermost layer group (step S40). Then, the loading information acquisition unit 32 extracts the popular article (step S41), selects the first pallet that contains the maximum number of popular articles and the second pallet that contains the minimum number of popular articles from among each of the pallets P (step S42), sets the lowermost layer group of the first pallet as the layer group of the popular articles and the second layer group of the second pallet as the layer group of the popular articles (step S43). Thereafter, the loading information acquisition unit 32 determines whether the selection of all pallets as the first pallet or the second pallet for the extracted popular articles is completed (step S44) and, when the selection is not completed (No at step S44), returns to step S42 and continues the selection processing of the first pallet and the second pallet from among the unselected pallets P. When all of the pallets are already selected (Yes at step S44), the loading information acquisition unit 32 determines whether all of the articles Q are extracted as popular articles from among each of the articles Q (step S45) and, when extraction is not completed (No at step S45), returns to step S41 and continues the extraction processing of the popular articles from among the articles Q that are not extracted and remained. When extraction is completed (Yes at step S45), the loading information acquisition unit 32 sets the stacking order for each of the pallets P such that the largest layer group and the smallest layer group are arranged alternately (step S46).

### Setting of Stacking Order

As described above, the loading information acquisition unit 32 sets, for each of the pallets P, the article information indicating the articles Q to be loaded on the pallet P and the stacking information indicating the stacking order of the articles Q. After the loading information is set, the information processing device 10 causes the loading order setting unit 34 to set the loading order indicating the order in which the stacking work of each of the pallets P is performed, based on the loading information of each of the pallets P. The loading order setting unit 34 also sets the supply pallet P0 to be used for supplying the articles Q to the pallet P based on the work information (supply pallet information). Hereinafter, this will be described in a specific manner.

Based on the loading information, the loading order setting unit 34 determines whether there are two pallets P to which layers of the same type of articles Q are allocated and, when there are two pallets P to which layers of the same type of articles Q are allocated, sets the loading order of those pallets P to be consecutive. In other words, in this case, the loading order is set such that the articles Q are loaded on one of the pallets P to which the layers of the same type of articles Q are allocated and, immediately thereafter, the articles Q are loaded on the other pallet P. This makes it possible to supply the same type of articles Q to the two pallets P in the consecutive loading order by using a single supply pallet P0. Thus, it is possible to suppress the number of times the supply pallet P0 is changed in the supply pallet placement area AR2, for example, and reduce the workload and work time.

### Selection of First Pallet

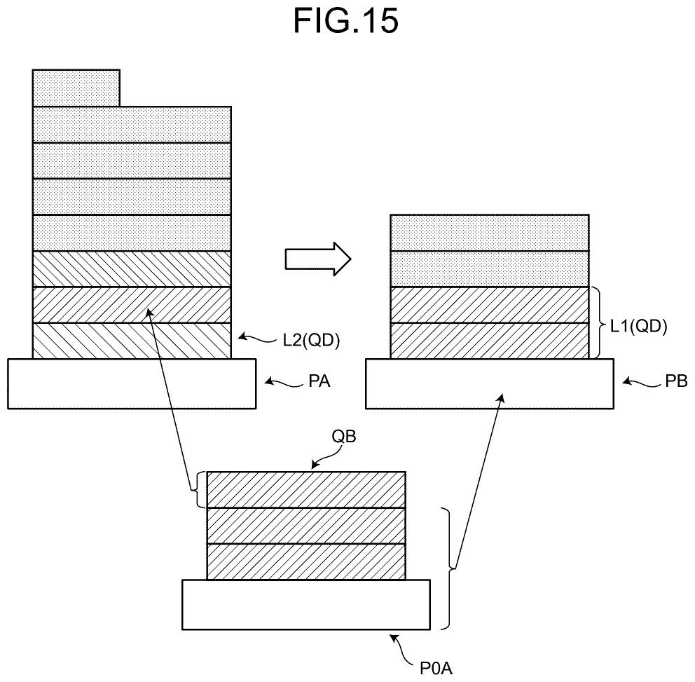

FIG. 15 is a schematic diagram for describing setting of the loading order. More preferably, in the first embodiment, the loading order setting unit 34 extracts the popular articles (target articles) from among the articles Q allocated to the pallets P for each of the shipping destinations. The loading order setting unit 34 extracts, from each of the pallets P, the pallet P where the popular articles are allocated to the layer above the lowermost layer group (the second layer group or higher layer group) as the first pallet. When there are a plurality of pallets P that have the popular articles allocated to the layer above the lowermost layer group, any one of those may be selected as the first pallet. As described above, the popular article herein means, but is not limited to, the article Q with the largest number of assigned shipping destinations. It may also refer to the type of articles Q selected by any method from among the articles Q allocated to the pallets P for each of the shipping destinations. For example, it may refer to the articles Q with the largest total number of shipment for each of the shipping destinations.

### Selection of Use Pallet for First Pallet

The loading order setting unit 34 selects the supply pallet P0 (use pallet) for supplying, to the first pallet, the articles Q other than the popular articles allocated to the first pallet, based on the loading information of the first pallet and the supply pallet information included in the work information. The loading order setting unit 34 selects the use pallet for supplying the articles Q other than the popular articles from among each of the supply pallets P0, based on the type and number of articles Q other than the popular articles allocated to the first pallet indicated in the loading information and the type and number of articles Q loaded on the supply pallet P0 indicated in the supply pallet information. More specifically, in the present embodiment, the loading order setting unit 34 determines whether there is a supply pallet P0 on which the same number of articles Q (same type of articles Q) are loaded with respect to the number of articles Q other than popular articles allocated to the first pallet. When there is the supply pallet P0 that have the same number of articles Q of the same type loaded thereon, the loading order setting unit 34 selects the supply pallet P0 as the use pallet for supplying the articles Q to the first pallet. When there are a plurality of supply pallets P0 that have the same number of articles Q of the same type loaded thereon, any one of those may be selected as the use pallet. In the meantime, when there is no supply pallet P0 on which the same number of articles Q of the same type are loaded, the loading order setting unit 34 selects, as the use pallet, the supply pallet P0 with the smallest number of articles Q from among each of the supply pallets P0.

After selecting the use pallet, the loading order setting unit 34 sets, as the articles Q planned to be supplied to the first pallet, the same number of articles Q as the number of articles allocated to the first pallet among the articles Q loaded on the use pallet.

The loading order setting unit 34 selects the use pallet by the above-described method for each of the articles Q other than the popular articles allocated to the first pallet. For the supply pallet P0 selected as the use pallet, the use pallet selection processing thereafter is performed by taking the number, which is the value acquired by subtracting the number planned to be supplied to the pallet P (the first pallet herein) from the original number of the articles Q loaded on the supply pallet P0, as the number of articles Q loaded on the supply pallet P0. This is also the same hereinafter.

### Selection of Second Pallet and Setting of Loading Order

The loading order setting unit 34 extracts, from each of the pallets P, the pallet P where the popular articles are allocated to the lowermost layer group as the second pallet. When there are a plurality of pallets P that have the popular articles allocated to the lowermost layer group, any one of those may be selected as the second pallet. In more detail, in the present embodiment, when the total number of the popular articles contained in the lowermost layer group of the pallet P and the popular articles contained in the first pallet is the same as the number of popular articles loaded on the supply pallet P0 indicated in the work information (supply pallet information), the pallet P (the pallet P with the popular articles allocated to the lowermost layer group) is selected as the second pallet. In other words, when there is a supply pallet P0 on which the same number of popular articles as the total number mentioned above are loaded, the loading order setting unit 34 selects the pallet P used for the calculation of the total number as the second pallet.

After selecting the second pallet, the loading order setting unit 34 determines the loading order such that the loading work of the second pallet is performed immediately after the loading work of the first pallet. The loading order setting unit 34 also selects, as the use pallet for supplying the popular articles to the first pallet and the second pallet, the supply pallet P0 on which the same number of popular articles as the total number of popular articles allocated to the first pallet and the second pallet are loaded. For example, in the example illustrated in FIG. 15, the articles QD as the popular articles are allocated to the second layer group L2 (layer above the lowermost layer group) of the pallet PA, and the articles QD as the popular articles are allocated to the lowermost layer group L1 of the pallet PB. The supply pallet POA has the same number of the articles QD (three layers) as the total number of the articles QD (one layer) in the second layer group L2 of the pallet PA and the articles QD (two layers) in the lowermost layer group L1 of the pallet PB. Therefore, in the example illustrated in FIG. 15, the loading order is set such that the loading work is performed on the pallet PB (second pallet) immediately after the pallet PA (first pallet), and the supply pallet POA is selected as the use pallet for supplying the articles QD to the pallets PA and PB. As described, by setting the supply pallet P0 with the number of popular articles just fit to the first pallet and the second pallet as the use pallet and continuously performing the loading work on the first pallet and the second pallet, the supply pallet P0 with the popular articles being emptied can be diverted as the pallet P (second pallet herein). Therefore, it is possible to reduce the load for transporting the supply pallet P0, for example, and to preferably reduce the work time and workload.

In the meantime, when there is no supply pallet P0 on which the same number of popular articles as the above-mentioned total number are loaded, the pallet P with the largest number of popular articles is selected as the second pallet from among the pallets P where the popular articles are allocated to the lowermost layer group. The loading order setting unit 34 determines the loading order such that the loading work of the second pallet is performed immediately after the loading work of the first pallet. Then, when the pallet P with the largest number of popular articles is selected as the second pallet, the loading order setting unit 34 selects, from among each of the supply pallets P0, the supply pallet P0 to which the largest number of popular articles are loaded as the use pallet for supplying the popular articles to the first pallet and the second pallet. That is, for example, when there is no such supply pallet POA as illustrated in FIG. 15 on which the articles QD for three layers are loaded, the supply pallet P0 where the largest number of the articles QD are loaded is selected as the use pallet for supplying the articles QD to the pallets PA and PB from among each of the supply pallets P0. Note that a single pallet P0 may be used as the use pallet for supplying the popular articles to the first pallet and the second pallet, or the use pallet for supplying the popular articles to the first pallet and the use pallet for supplying the popular articles to the second pallet may be selected separately.

Furthermore, for the second pallet, the loading order setting unit 34 also selects the use pallet for supplying, to the second pallet, the articles Q other than the popular articles allocated to the second pallet. The selection method of the use pallet herein is the same as the selection method of the use pallet for supplying the articles Q other than the popular articles to the first pallet, so the explanation thereof is omitted.

As described above, in the present embodiment, the first pallet and the second pallet are selected, the loading order is set such that loading work of the second pallet is performed immediately after the first pallet, and the use pallets for the first pallet and the second pallet are selected. Thereafter, the loading order setting unit 34 selects the second pallet anew as the first pallet, sets the articles Q contained in the layer above the lowermost layer group of the newly selected first pallet (the original second pallet) as the popular article, and performs the same processing described above. The loading order setting unit 34 executes the present processing until all of the pallets are selected as the first pallet or the second pallet to set the loading order for all of the pallets and to select the use pallet.

### Processing Flow

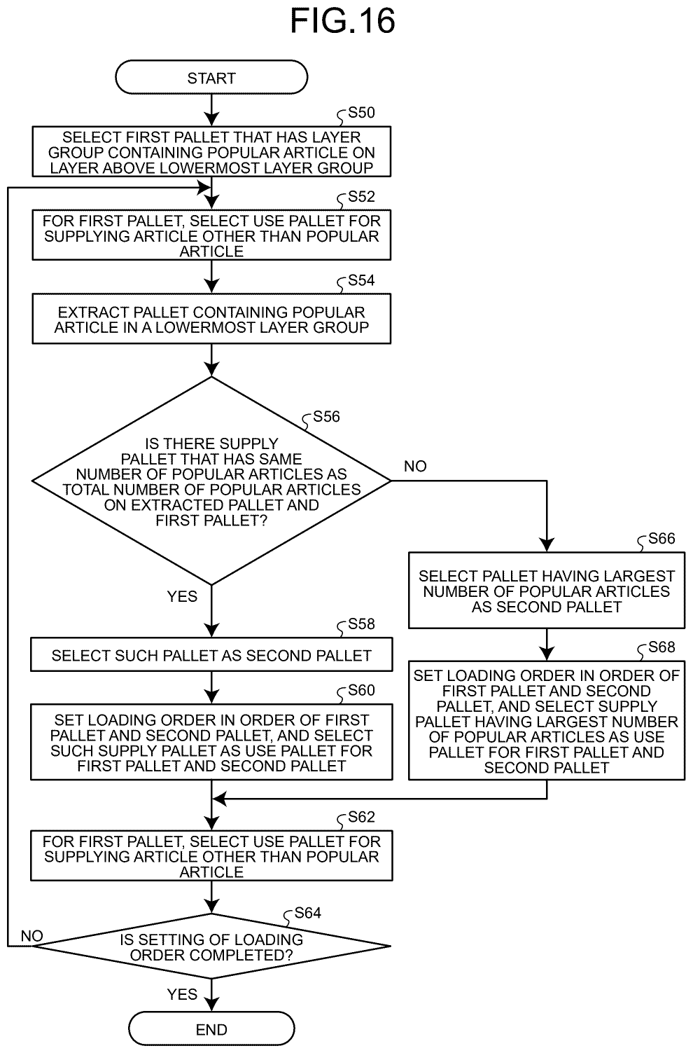

Next, a processing flow for setting the above-described loading order and use pallet will be described. FIG. 16 is a flowchart for describing the processing flow for setting the loading order and the use pallet. As illustrated in FIG. 16, the loading order setting unit 34 selects, as the first pallet, the pallet P in which the layer group L containing the popular articles is allocated to the layer above the lowermost layer group (step S50), and selects, for the first pallet, the use pallet for supplying the articles Q other than popular articles to the first pallet (step S52). Then, the loading order setting unit 34 extracts the pallet P that contains the popular articles in the lowermost layer group (step S54), and determines whether there is the supply pallet P0 on which the same number of popular articles as the total number of popular articles on the extracted pallet P and the first pallet are loaded (step S56). When there is the supply pallet P0 on which the same number of popular articles as the total number are loaded (Yes at step S56), the loading order setting unit 34 selects the extracted pallet P as the second pallet (step S58), and while setting the loading order in the order of the first pallet and the second pallet, selects the pallet P0 on which the same number of popular articles as the total number are loaded as the use pallet for supplying the popular articles to the first pallet and the second pallet (step S60). Thereafter, the loading order setting unit 34 selects, for the second pallet, the use pallet for supplying the articles other than the popular articles (step S62) and, when the loading order is already set for all of the pallets P (Yes at step S64), ends the processing. When the loading order is not set for all of the pallets P (No at step S64), the loading order setting unit 34 returns to step S52 to set the second pallet as the new first pallet, and continues the processing.

Furthermore, when there is no supply pallet P0 on which the same number of popular articles as the total number are loaded (No at step S56), the loading order setting unit 34 selects the pallet P with the largest number of popular articles as the second pallet from among the extracted pallets P (step S66). While setting the loading order in the order of the first pallet and the second pallet, the loading order setting unit 34 selects the pallet P0 on which a largest number of popular articles are loaded as the use pallet for supplying the popular articles to the first pallet and the second pallet (step S68), and proceeds to step S62.

### Execution of Loading Work

As described above, the information processing device 10 sets the loading information indicating the type and number of articles Q to be allocated to the pallets and the stacking order of the articles Q, and the loading order indicating the order of the pallets in which loading is to be performed, to make a loading plan. The loading plan may also include information of the supply pallets used for supplying the articles Q to the pallets P. The output control unit 36 of the information processing device 10 outputs the generated loading plan (information including the loading information and the loading order) to external devices. For example, in the present embodiment, the output control unit 36 outputs the loading plan to other devices of the loading system 100 and causes the other devices to execute loading work (loading the articles Q on the pallets P) according to the loading plan. That is, for example, the output control unit 36 transmits the loading plan to a control unit (not illustrated) that controls the operation of the loading device 14, and the control unit controls the operation of loading device 14 to execute the loading work according to the loading plan. Furthermore, for example, the output control unit 36 transmits the loading plan to a control unit (not illustrated) that controls the operation of the mobile body 12, and the control unit controls the operation of the mobile body 12 to execute the loading work according to the loading plan.

### Effects

As described above, in the present embodiment, the loading order for each of the pallets P is set based on the loading information for the pallets P. According to present embodiment, the loading order of the pallets P is set in accordance with the type, number, and stacking order of the articles Q that are planned to be loaded on each of the pallets P. Therefore, a loading plan can be created appropriately in accordance with the work content. Moreover, in the present embodiment, the stacking orders in the first pallet where the popular articles are allocated to the layer above the lowermost layer group and in the second pallet where the popular articles are allocated to the lowermost layer group are set to be consecutive. This makes it possible to more appropriately suppress the number of times the supply pallets P0 placed in the supply pallet placement area AR2 is changed, thereby reducing the workload and work time. Furthermore, in the present embodiment, the supply pallet P0 with the number of popular articles just fit to the first pallet and the second pallet is set as the use pallet, and the loading work of the first pallet and the second pallet is continuously performed. Thereby, the supply pallet P0 with the popular articles being emptied can be diverted as the second pallet.

Therefore, it is possible to reduce the load for transporting the supply pallet P0, for example, and to preferably reduce the work time and workload.

### Second Embodiment

Next, a second embodiment will be described. In the second embodiment, the loading order setting method is different from the first embodiment. In the second embodiment, explanation of the components that share the same configuration with the first embodiment will be omitted.

### Setting of Loading Information

In the first embodiment, when setting the loading information, the loading information acquisition unit 32 sets the layer group L containing the popular articles as the lowermost layer group for the first pallet with the largest number of popular articles, and sets the layer group L containing the popular articles as the second layer group (the second layer group from the bottom) for the second pallet with the smallest number of popular articles. In the meantime, in the second embodiment, the loading information acquisition unit 32 sets the layer group L containing the popular articles as the lowermost layer group for the first pallet, and sets the layer group L containing the popular articles as the uppermost layer group for the second pallet. Then, the processing is repeated in which the second pallet is set as a new first pallet, the articles Q on the uppermost layer group of the new first pallet are considered as the popular articles, the pallet P containing the popular articles is set as the second pallet, and the popular articles on the second pallet are set on the lowermost layer group. Other than this point, the loading information setting method is the same as that of the first embodiment, so the explanation is omitted.

### Setting of Stacking Order

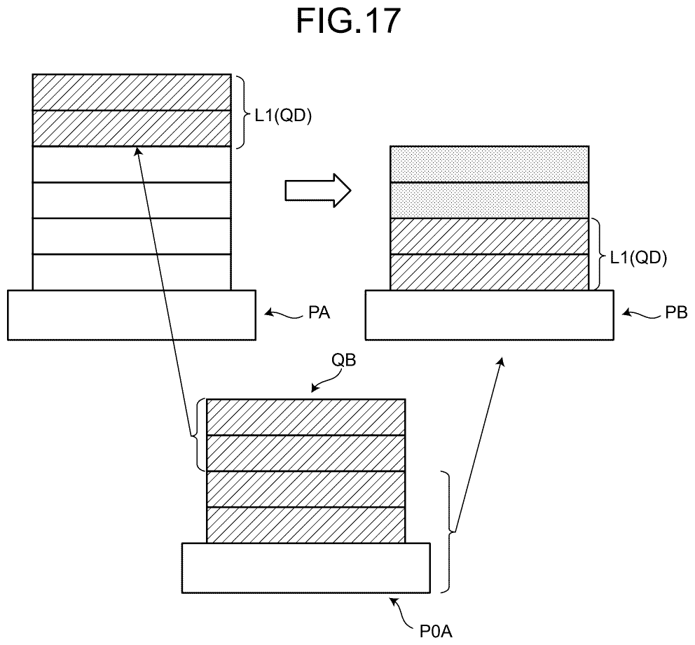

FIG. 17 is a schematic diagram for describing setting of the loading order according to the second embodiment. In the second embodiment, as in the first embodiment, the loading order setting unit 34 sets the loading order based on the loading information of each of the pallets P and, when there are two pallets P to which layers of the same type of articles Q are allocated, preferably sets the loading order of those pallets P to be consecutive. However, in the second embodiment, the more preferable setting method of the loading order and the use pallet is different from that of the first embodiment. Hereinafter, this will be described in a specific manner.

In the second embodiment, the loading order setting unit 34 selects, as the first pallet, the pallet P that has the largest number of articles Q in the uppermost layer group among each of the pallets P. However, the selection method of the first pallet is not limited thereto, and the first pallet may be selected from each of the pallets P using any method.

The loading order setting unit 34 selects, as the second pallet, the pallet P that has the same type of articles Q as the articles Q contained in the uppermost layer group of the first pallet in the lowermost layer group from among each of the pallets P. When there are a plurality of pallets P that have the same type of articles Q as the articles Q contained in the uppermost layer group of the first pallet in the lowermost layer group, any one of those may be selected as the second pallet.

After selecting the second pallet, the loading order setting unit 34 determines the loading order such that the loading work of the second pallet is performed immediately after the loading work of the first pallet. Thereafter, the loading order setting unit 34 selects the second pallet as a new first pallet, selects anew a second pallet that contains the articles Q contained in the uppermost layer group of the newly selected first pallet (original second pallet) in the lowermost layer group, and performs the same processing described above. The loading order setting unit 34 executes the present processing until all of the pallets are selected as the first pallet or the second pallet to set the loading order for all of the pallets. As described, by continuously performing the loading work on the first pallet and the second pallet including the same articles Q on the uppermost layer group and the lowermost layer group, the supply pallet P0 having the articles reloaded to the first pallet can be diverted to the second pallet. This makes it possible to reduce the number of times the supply pallet is moved from the supply pallet placement area AR2 to another place and continue the loading work, and to preferably reduce the work time and workload.

### Selection of Use Pallet

After setting the loading order, the loading order setting unit 34 selects the use pallet for supplying the articles Q to each of the pallets P.

Specifically, the loading order setting unit 34 extracts one type of articles Q1 by any method from among the articles Q allocated to the pallets P for each of the shipping destinations. Then, the loading order setting unit 34 extracts the pallet P that contains the extracted article Q1 in the lowermost layer group from among each of the pallets P for which the loading order is set, and selects, as the first pallet, the pallet P that has the largest number of articles Q1 from among the pallets P that contain the articles Q1 in the lowermost layer group.

The loading order setting unit 34 selects, as the second pallet, the pallet P to which loading is performed before the first pallet and to which the articles Q1 included in the lowermost layer group of the first pallet are allocated. Then, the loading order setting unit 34 determines whether there is a supply pallet P0 that has the same number of articles Q1 as the total number of articles Q1 in the lowermost layer group of the first pallet and the articles Q1 included in the second pallet. When there is the supply pallet P0 that has the same number of articles Q1 loaded thereon, the loading order setting unit 34 selects the supply pallet P0 as the use pallet for supplying the articles Q1 to the first pallet and the second pallet. When there is no supply pallet P0 that has the same number of articles Q1 loaded thereon, another pallet P to which loading is performed before the first pallet and to which the articles Q1 included in the lowermost layer group of the first pallet are allocated is selected as a new second pallet, and the same processing is performed.

For example, in the example illustrated in FIG. 17, the articles QD are allocated to the uppermost layer group L1 of the pallet PA, and the articles QD are allocated to the lowermost layer group L1 of the pallet PB. The supply pallet POA is loaded with the same number of the articles QD (four layers) as the total number of the articles QD (two layers) in the uppermost layer group L1 of the pallet PA and the articles QD (two layers) in the lowermost layer group L1 of the pallet PB. Therefore, in the example illustrated in FIG. 17, the loading order is set such that the loading work is performed on the pallet PB (second pallet) immediately after the pallet PA (first pallet), and the supply pallet POA is selected as the use pallet for supplying the articles QD to the pallets PA and PB. As described, by setting the supply pallet P0 with the number of popular articles Q1 just fit to the first pallet and the second pallet as the use pallet, the supply pallet P0 with the popular articles Q1 being emptied by reloading the necessary pieces of articles Q1 to the first pallet can be diverted as the pallet P (second pallet herein). Therefore, it is possible to reduce the load for transporting the supply pallet P0, for example, and to preferably reduce the work time and workload.

The loading order setting unit 34 determines whether all of the pallets P correspond to the first pallet or the second pallet, and the same processing described above is performed to allocate the use pallet for those corresponding to the first pallet or the second pallet. In the meantime, for the pallets P that do not correspond to the first pallet and the second pallet, the use pallet is allocated by a method described below. Hereinafter, the pallet P that does not correspond to the first pallet and the second pallet is referred to as a remaining pallet as appropriate to describe a use pallet allocation method.

The loading order setting unit 34 extracts, from a plurality of remaining pallets, a plurality of (preferably two) remaining pallets to which the articles Q1 are allocated. Then, the loading order setting unit 34 determines whether there is a supply pallet P0 that has the same number of articles Q1 as the total number of articles Q1 allocated to the extracted remaining pallets. When there is the supply pallet P0 that has the same number of articles Q1 loaded thereon, the loading order setting unit 34 selects the supply pallet P0 as the use pallet for supplying the articles Q1 to the extracted remaining pallets. The loading order setting unit 34 repeats the processing for all of the remaining pallets until there are no more supply pallets P0 on which the same number of articles Q1 as the total number of articles Q1 are loaded.

When there is a remaining pallet to which a use pallet is not allocated, the loading order setting unit 34 selects, as the use pallet for supplying the articles Q1 to the remaining pallet, the supply pallet P0 on which a greater number of articles Q1 than the number of articles Q1 allocated to the remaining pallet are loaded.

The loading order setting unit 34 selects the use pallet for supplying the articles Q1 to each of the pallets P where the articles Q1 are allocated by using the method described above. Thereafter, the loading order setting unit 34 extracts, as the new article Q1, the articles Q that are not extracted as the articles Q1 from among the articles Q allocated to the pallets P for each of the shipping destinations, and performs the processing for selecting the use pallet in the same manner described above. The loading order setting unit 34 selects the use pallet for all of the articles Q by performing the processing until all of the articles Q are extracted as the articles Q1.

### Processing Flow

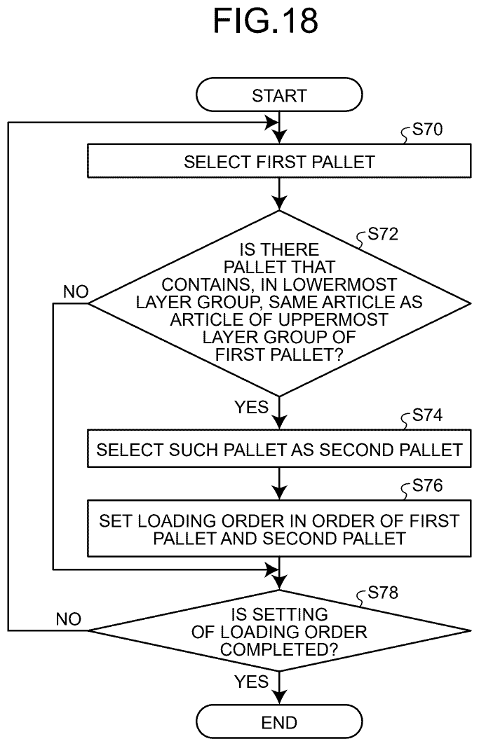

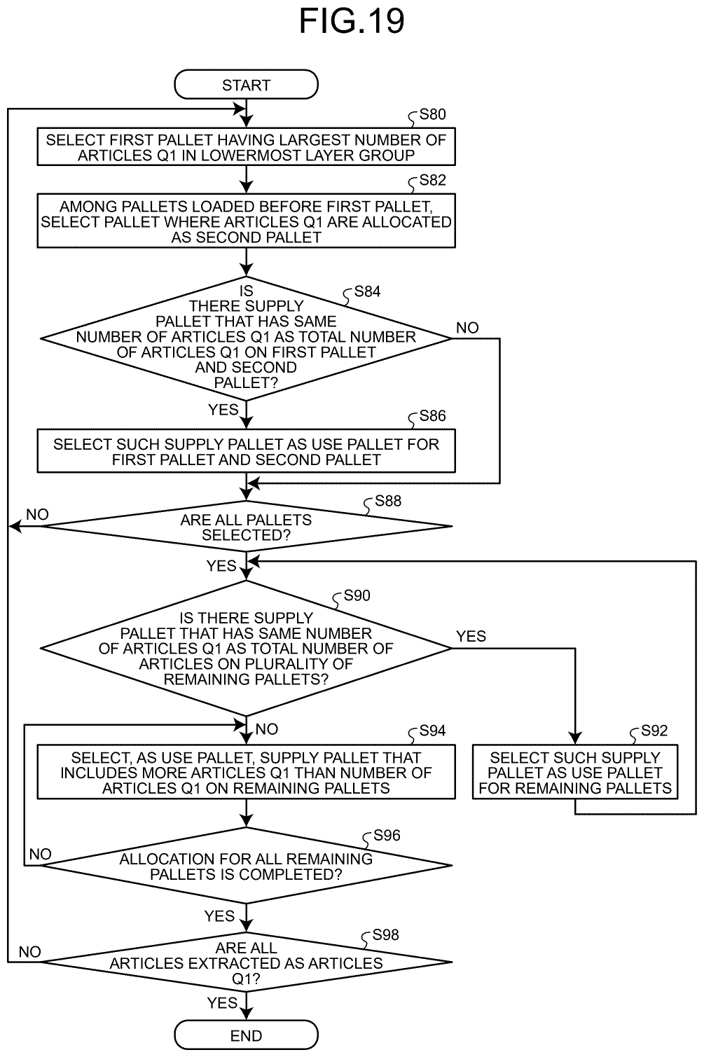

Next, processing flows for setting the loading order and for setting the use pallet according to the above-described second embodiment will be described. FIG. 18 is a flowchart for describing the processing flow for setting the loading order according to the second embodiment, and FIG. 19 is a flowchart for describing the processing flow for setting the use pallet according to the second embodiment.

As illustrated in FIG. 18, when setting the loading order, the loading order setting unit 34 selects the first pallet from among each of the pallets P (step S70), determines whether there is a pallet P in which the same articles Q as the articles Q in the uppermost layer group of the first pallet are allocated to the lowermost layer group (step S72) and when there is (Yes at step S72), selects that pallet P as the second pallet (step S74). Then, the loading order setting unit 34 sets the loading order in the order of the first pallet and the second pallet (step S76), and when setting of the loading order for all of the pallets P is completed (Yes at step S78), ends the present processing, but when not completed (No at step S78), returns to step S70 and repeats the processing. When there is no pallet P that has the same articles Q as the articles Q in the uppermost layer group of the first pallet allocated to the lowermost layer group (No at step S72), the loading order setting unit 34 proceeds to step S78.

As illustrated in FIG. 19, when setting the use pallet, the loading order setting unit 34 extracts the articles Q1 and selects the first pallet that has a largest number of articles Q1 included in the lowermost layer group from among the pallets P that include the articles Q1 in the lowermost layer group (step S80), and selects the second pallet to which the articles Q1 are allocated from among the pallets P where loading is performed before the first pallet (step S82). Then, the loading order setting unit 34 determines whether there is a supply pallet P0 that has the same number of articles Q1 as the total number of articles Q1 on the first pallet and on the second pallet (step S84) and, when there is (Yes at step S84), selects that supply pallet P0 as the use pallet for supplying the articles Q1 to the first pallet and the second pallet (step S86). Moreover, it is preferable to use this supply pallet P0 as the supply pallet for the first pallet and divert the supply pallet P0, from which supply of the articles Q1 to the first pallet is completed, to the second pallet. In other words, the supply pallet P0, from which supply of the articles Q1 to the first pallet is completed, is the source for supplying the articles Q1 to the second pallet, so that it is also referred to as the supply pallet for the second pallet. Also, it is used as the second pallet without reloading, so that it is also the pallet diverted to the second pallet itself. Thereafter, the loading order setting unit 34 proceeds to step S88, when all of the pallets P are not selected as the first pallet or the second pallet (No at step S88), returns to step S80, and when all of the pallets P are already selected as the first pallet or the second pallet (Yes at step S88), proceeds to step S90. When there is no supply pallet P0 that has the same number of articles Q1 as the total number of articles Q1 on the first pallet and on the second pallet (No at step S84), the loading order setting unit 34 also proceeds to step S88.

At step S90, the loading order setting unit 34 extracts a plurality of remaining pallets to which the articles Q1 are allocated from the remaining pallets for which the use pallet for supplying the articles Q1 is not selected. Then, the loading order setting unit 34 determines whether there is a supply pallet P0 that has the same number of articles Q1 as the total number of articles Q1 on a plurality of remaining pallets to which the articles Q1 are allocated (step S90) and, when there is (Yes at step S90), selects that supply pallet P0 as the use pallet for supplying the articles Q1 to those remaining pallets (step S92). After executing step S92, the loading order setting unit 34 returns to step S90 and repeats the processing until there are no more supply pallets P0 on which the same number of articles Q1 as the total number of articles Q1 on the remaining pallets are loaded. In the meantime, when there are no more supply pallets P0 on which the same number of articles Q1 as the total number of articles Q1 on the remaining pallets are loaded (No at step S90), the loading order setting unit 34 selects, as the use pallet for supplying the articles Q1 to the remaining pallets, the supply pallet P0 that has a greater number of articles Q1 than the number of articles Q1 allocated to the remaining pallets to which the use pallet is not allocated (step S94). Then, when selection of the use pallet for supplying the articles Q1 is not completed for all of the remaining pallets (No at step S96), the loading order setting unit 34 returns to step S94. In the meantime, when selection of the use pallet for supplying the articles Q1 is not completed for all of the remaining pallets, the loading order setting unit 34 proceeds to step S98. When extraction of all the articles Q as the articles Q1 is not completed at step S98 (No at step S98), the loading order setting unit 34 returns to step S80, extracts new articles Q as the articles Q1, and repeats processing. When extraction of all the articles Q as the articles Q1 is completed (Yes at step S98), the loading order setting unit 34 ends the processing.

As described, in the second embodiment, by continuously performing the loading work on the first pallet and the second pallet containing the same articles Q on the uppermost layer group and the lowermost layer group, it is possible to reduce the number of times the supply pallet P0 from which the articles are reloaded once is moved from the supply pallet placement area AR2 to another place and continue the loading work, and to preferably reduce the work time and workload.

### Effect of Present Disclosure

As described above, an information processing method according to a first aspect of the present disclosure includes: a step of acquiring, for each of a plurality of pallets P, loading information indicating type and number of articles Q allocated to the pallet P as well as a stacking order of the articles Q on the pallet P; and a step of setting a loading order indicating order of the pallets P where loading is performed, based on the loading information regarding the pallets P. According to the present disclosure, the loading order of the pallets P is set in accordance with the type, number, and stacking order of the articles Q that are planned to be loaded on each of the pallets P. Therefore, it is possible to create a loading plan appropriately in accordance with the work content.

An information processing method according a second aspect of the present disclosure is the information processing method according to the first aspect, in which, in the step of setting the loading order, it is determined based on the loading information whether there are two pallets P where a same type of the articles Q is allocated, and when there are the two pallets P where the same type of the articles Q is allocated, the loading order of those pallets is set to be consecutive. This makes it possible to supply the same type of articles Q to the two pallets P in the consecutive loading order by using a single supply pallet P0. Thus, it is possible to suppress the number of times the supply pallet P0 is changed and to reduce the workload and work time.

An information processing method according to a third aspect of the present disclosure is the information processing method according to the second aspect, in which, in the step of setting the loading order, it is determined based on the loading information whether there are a first pallet where a target article is allocated to a layer above a lowermost layer group and a second pallet where the target article is allocated to a lowermost layer group, and when there are the first pallet and the second pallet, the loading order is set such that loading on the second pallet is performed immediately after loading on the first pallet. This makes it possible to continuously supply the same type of articles Q to the two pallets P in the consecutive loading order by using a single supply pallet P0. Thus, it is possible to suppress the number of times the supply pallet P0 is changed and to reduce the workload and work time.

An information processing method according to a fourth aspect of the present disclosure is the information processing method according to the third aspect, further including: a step of acquiring information regarding number of the target articles on a supply pallet P0 that has the target articles to be loaded on the pallet P, in which, in the step of setting the loading order, when a total number of the target articles on the pallet where the target articles are allocated to the lowermost layer group and the target articles allocated to the first pallet is same as the number of target articles loaded on the supply pallet P0, the pallet P is selected as the second pallet. According to the present disclosure, it is possible to set the supply pallet P0 with the number of popular articles just fit to the first pallet and the second pallet as the use pallet, and continuously perform the loading work on the first pallet and the second pallet. Thereby, the supply pallet P0 with the popular articles being emptied can be diverted as the second pallet. Therefore, it is possible to reduce the load for transporting the supply pallet P0, for example, and to preferably reduce the work time and workload.

An information processing method according to a fifth aspect of the present disclosure is the information processing method according to the fourth aspect, in which, in the step of setting the loading order, when there is no such supply pallet P0 on which the same number of the target articles as the total number are loaded, a pallet P in which the number of the target articles allocated therein is largest is selected as the second pallet from among the pallets P where the target articles are allocated to the lowermost layer group. According to the present disclosure, since the second pallet is selected in such a manner, more target articles on the supply pallet P0 can be consumed earlier, thereby making it possible to preferably reduce the work time and workload.

An information processing method according to a sixth aspect of the present disclosure is the information processing method according to the second aspect, in which, in the step of setting the loading order, it is determined based on the loading information whether there are a first pallet where a target article is allocated to an uppermost layer group and a second pallet where the target article is allocated to a lowermost layer group, and when there are the first pallet and the second pallet, the loading order is set such that loading on the second pallet is performed immediately after loading on the first pallet. According to the present disclosure, by continuously performing the loading work on the first pallet and the second pallet containing the same articles Q in the uppermost layer group and the lowermost layer group, it is possible to reduce the number of times the supply pallet P0 from which the articles are reloaded once is moved from the supply pallet placement area AR2 to another place and continue the loading work, and to preferably reduce the work time and workload.

An information processing method according to a seventh aspect of the present disclosure is the information processing method according to any one of the first to sixth aspects, in which, in the step of acquiring the loading information, the articles Q loaded on the pallet P are classified into a whole article that is loaded over an entire area of one layer of the pallet P, and an individual article that is loaded only in a part of the entire area of one layer of the pallet P, and the loading information is set such that the individual article and the whole article that is a same type as the individual article are loaded on a same pallet P. According to the present disclosure, the same type of individual articles and whole articles are loaded on a single pallet P. Therefore, the same articles Q can be loaded without changing the pallet P, which makes it possible to preferably reduce the work time and workload.

An information processing method according to an eighth aspect of the present disclosure is the information processing method according to the seventh aspect, in which, in the step of acquiring the loading information, a stacking order for each of layer groups L that include layers with the articles Q of a same type is set as the loading information. According to the present disclosure, the same type of articles Q are stacked continuously. Therefore, it is possible to reduce number of times the supply pallet P0 is changed, and to preferably reduce the work time and workload.

An information processing method according to a ninth aspect of the present disclosure is the information processing method according to the eighth aspect, in which, in the step of acquiring the loading information, the loading information is set such that a layer group L that includes a layer with a heaviest weight among the layers with the articles Q included in the layer groups L is set as a lowermost layer group. According to the present disclosure, the weight balance can be maintained by setting the layer with the heavier articles Q as the lowermost layer.

An information processing method according to a tenth aspect of the present disclosure is the information processing method according to the eighth or ninth aspect, in which, in the step of acquiring the loading information, the loading information is set such that the layer group L that includes the individual article Q is set as an uppermost layer group. According to the present disclosure, by setting the individual article as the uppermost layer, it is possible to load as many articles Q as possible on the layers below the individual article.

An information processing method according to an eleventh aspect of the present disclosure is the information processing method according to any one of the eighth to tenth aspects, in which, in the step of acquiring the loading information, the loading information is set such that a largest layer group that has a largest number of the articles Q and a smallest layer group that has a smallest number are stacked alternately. According to the present disclosure, by alternately stacking the largest layer group and the smallest layer group, it is possible to reduce the chances for waiting until the change of the supply pallet P0 is completed.

A loading method according to a twelfth aspect of the present disclosure loads the articles on the pallets P, based on the loading information and the loading order set by the information processing method according to any one of the first to eleventh aspects. According to present disclosure, it is possible to appropriately perform loading in accordance with the work content.

A computer program according to a thirteenth aspect of the present disclosure causes a computer to execute: a step of acquiring, for each of a plurality of pallets P, loading information indicating type and number of articles Q allocated to the pallet P as well as a stacking order of the articles Q on the pallet P; and a step of setting a loading order indicating order of the pallets P where loading is performed, based on the loading information regarding the pallets P. According to the present disclosure, it is possible to appropriately create a loading plan in accordance with the work content.

An information processing device according to a fourteenth aspect of the present disclosure includes: the loading information acquisition unit 32 that acquires, for each of a plurality of pallets P, loading information indicating type and number of articles Q allocated to the pallet P as well as a stacking order of the articles Q on the pallet P; and the loading order setting unit 34 that sets a loading order indicating order of the pallets P where loading is performed, based on the loading information regarding the pallets P. According to the present disclosure, it is possible to appropriately create a loading plan in accordance with the work content.

While the embodiments of the present disclosure are described above, embodiments are not limited by the content of the embodiments described above.

Furthermore, the structural components described above also include those that can be readily assumed by those skilled in the art, those that are substantially identical, and those that are in the so-called range of equivalence. The structural components described above can also be combined as appropriate. Furthermore, various omissions, substitutions, or modifications of the structural components can be made without departing from the gist of the embodiments described above.

### REFERENCE SIGNS LIST

10 Information processing device
12 Mobile body
14 Loading device
30 Work information acquisition unit
32 Loading information acquisition unit
34 Loading order setting unit
L Layer group
P0 Supply pallet
P Pallet
Q Article

1. An information processing method comprising:
acquiring, for each of a plurality of pallets, loading information indicating a type and a number of articles allocated to the pallet as well as a stacking order of the articles on the pallet; and
setting a loading order indicating order of the pallets where loading is performed, based on the loading information regarding the pallets, wherein
the setting the loading order includes
determining based on the loading information whether there are a first pallet where a target article is allocated to a layer above a lowermost layer group and a second pallet where the target article is allocated to a lowermost layer group, and
setting, when there are the first pallet and the second pallet, the loading order such that loading on the second pallet is performed immediately after loading on the first pallet, and
the information processing method further comprises acquiring information regarding a number of the target articles on a supply pallet that has the target articles to be loaded on the pallet, wherein
the setting the loading order includes selecting, when a total number of the target articles allocated to the pallet where the target articles are allocated to the lowermost layer group and the target articles allocated to the first pallet is same as the number of the target articles loaded on the supply pallet, the pallet as the second pallet.

2. The information processing method according to claim 1, wherein the setting the loading order includes
determining based on the loading information whether there are two pallets where a same type of the articles is allocated, and
setting, when there are the two pallets where a same type of the articles is allocated, the loading order of those pallets to be consecutive.

3. (canceled)

4. (canceled)

5. The information processing method according to claim 1, wherein the setting the loading order includes selecting, when there is no supply pallet on which the same number of the target articles as the total number are loaded, a pallet in which a number of the target articles allocated thereto is largest, as the second pallet from among the pallets where the target articles are allocated to the lowermost layer group.

6. The information processing method according to claim 2, wherein the setting the loading order includes
determining based on the loading information whether there are a first pallet where a target article is allocated to an uppermost layer group and a second pallet where the target article is allocated to a lowermost layer group, and
setting, when there are the first pallet and the second pallet, the loading order such that loading on the second pallet is performed immediately after loading on the first pallet.

7. The information processing method according to claim 1, wherein the acquiring the loading information includes
classifying the articles loaded on the pallet into a whole article that is loaded over an entire area of one layer of the pallet, and an individual article that is loaded only in a part of the entire area of one layer of the pallet, and
setting the loading information such that the individual article and the whole article that is a same type as the individual article are loaded on a same pallet.

8. The information processing method according to claim 7, wherein the acquiring the loading information includes setting, as the loading information, a stacking order for each of layer groups that include layers with the articles of a same type.

9. The information processing method according to claim 8, wherein the acquiring the loading information includes setting the loading information such that a layer group that includes a layer with a heaviest weight among the layers with the articles included in the layer groups is set as a lowermost layer group.

10. The information processing method according to claim 8, wherein the acquiring the loading information includes setting the loading information such that the layer group that includes the individual article is set as an uppermost layer group.

11. The information processing method according to claim 8, wherein the acquiring the loading information includes setting the loading information such that a largest layer group that has a largest number of the articles and a smallest layer group that has a smallest number of the articles are stacked alternately.

12. A loading method for loading the articles on the pallets based on the loading information and the loading order set by the information processing method according to claim 1.

13. A non-transitory computer-readable recording medium having stored thereon a program causing a computer to execute:
acquiring, for each of a plurality of pallets, loading information indicating a type and a number of articles allocated to the pallet as well as a stacking order of the articles on the pallet; and
setting a loading order indicating order of the pallets where loading is performed, based on the loading information regarding the pallets, wherein
the setting the loading order includes
determining based on the loading information whether there are a first pallet where a target article is allocated to a layer above a lowermost layer group and a second pallet where the target article is allocated to a lowermost layer group, and
setting, when there are the first pallet and the second pallet, the loading order such that loading on the second pallet is performed immediately after loading on the first pallet, and
the computer program further causes the computer to execute acquiring information regarding a number of the target articles on a supply pallet that has the target articles to be loaded on the pallet, wherein
the setting the loading order includes selecting, when a total number of the target articles allocated to the pallet where the target articles are allocated to the lowermost layer group and the target articles allocated to the first pallet is same as the number of the target articles loaded on the supply pallet, the pallet as the second pallet.

14. An information processing device comprising:
a loading information acquisition unit that acquires, for each of a plurality of pallets, loading information indicating a type and a number of articles allocated to the pallet as well as a stacking order of the articles on the pallet; and
a loading order setting unit that sets a loading order indicating order of the pallets where loading is performed, based on the loading information regarding the pallets, wherein
the loading order setting unit determines based on the loading information whether there are a first pallet where a target article is allocated to a layer above a lowermost layer group and a second pallet where the target article is allocated to a lowermost layer group, and sets, when there are the first pallet and the second pallet, the loading order such that loading on the second pallet is performed immediately after loading on the first pallet,
the loading information acquisition unit acquires information regarding a number of the target articles on a supply pallet that has the target articles to be loaded on the pallet, and
the loading order setting unit selects, when a total number of the target articles allocated to the pallet where the target articles are allocated to the lowermost layer group and the target articles allocated to the first pallet is same as the number of the target articles loaded on the supply pallet, the pallet as the second pallet.
